(19) United States
(12) Patent Application Publication
(10) Pub. No.: US 2026/0330367 A1
(43) Pub. Date: Oct. 22, 2026

(54) METHOD FOR GENERATING DOCUMENT, ELECTRONIC DEVICE AND STORAGE MEDIUM

(71) Applicant: Beijing Baidu Netcom Science Technology Co., Ltd., Beijing (CN)

(72) Inventor: Tao Yang, Beijing (CN)

(21) Appl. No.: 19/712,399

(22) Filed: Jun. 18, 2026

(30) Foreign Application Priority Data
Dec. 19, 2025 (CN) 202511937094.X

(51) Int. Cl. G06Q 10/0631; G06F 8/35

(52) U.S. Cl. CPC G06Q 10/06316; G06F 8/35

(57) ABSTRACT

Provided is a method for generating a document, an electronic device and a storage medium, relating to the field of computer technology, and particularly to the fields of artificial intelligence, deep learning, large model, natural language processing and other technologies. The method includes: obtaining a document generation request; obtaining a task planning result based on the document generation request by using an orchestration agent, the task planning result comprising a plurality of sub-tasks; for each of the plurality of sub-tasks, generating a tool module corresponding to the sub-task by using the orchestration agent, to obtain a plurality of tool modules in one-to-one correspondence to the plurality of sub-tasks; and generating a target document by using the plurality of tool modules to execute the plurality of sub-tasks.

### CROSS-REFERENCE TO RELATED APPLICATIONS

The present application claims priority to Chinese Patent Application No. CN202511937094.X, filed with the China National Intellectual Property Administration on Dec. 19, 2025, the disclosure of which is hereby incorporated herein by reference in its entirety.

### TECHNICAL FIELD

The present disclosure relates to the field of computer technology, particularly to the fields of artificial intelligence, deep learning, large model, natural language processing and other technologies, and specifically to a method and an apparatus for generating a document, an electronic device and a storage medium.

### BACKGROUND

With the advent of the information age, the writing of technical documents has become a key link in enterprise innovation, product development and project delivery. The rapid development of science and technology and the continuous specialization of professional fields have further intensified the market's urgent demand for high-quality technical documents.

### SUMMARY

The present disclosure provides a method and an apparatus for generating a document, an electronic device and a storage medium.

According to a first aspect of the present disclosure, provided is a method for generating a document, including: obtaining a document generation request; obtaining a task planning result based on the document generation request by using an orchestration agent, where the task planning result includes a plurality of sub-tasks; for each of the plurality of sub-tasks, generating a tool module corresponding to the sub-task by using the orchestration agent, to obtain a plurality of tool modules in one-to-one correspondence to the plurality of sub-tasks; and generating a target document by using the plurality of tool modules to execute the plurality of sub-tasks.

According to a second aspect of the present disclosure, provided is an apparatus for generating a document, including: a request obtaining unit configured to obtain a document generation request; a task planning unit configured to obtain a task planning result based on the document generation request by using an orchestration agent, where the task planning result includes a plurality of sub-tasks; a tool module generation unit configured to, for each of the plurality of sub-tasks, generate a tool module corresponding to the sub-task by using the orchestration agent, to obtain a plurality of tool modules in one-to-one correspondence to the plurality of sub-tasks; and a document generation unit configured to generate a target document by using the plurality of tool modules to execute the plurality of sub-tasks.

According to a third aspect of the present disclosure, provided is an electronic device, including: at least one processor; and a memory connected in communication with the at least one processor; where the memory stores an instruction executable by the at least one processor, and the instruction, when executed by the at least one processor, enables the at least one processor to execute the method provided in the first aspect of the present disclosure.

According to a fourth aspect of the present disclosure, provided is a non-transitory computer-readable storage medium storing a computer instruction thereon; and the computer instruction is used to cause a computer to execute the method provided in the first aspect of the present disclosure.

According to a fifth aspect of the present disclosure, provided is a computer program product including a computer program; and the computer program implements the method provided in the first aspect of the present disclosure, when executed by a processor.

Using the present disclosure can improve the output quality of the target document.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flowchart of a method for generating a document according to an embodiment of the present disclosure;

FIG. 2 is an architecture diagram of an intelligent document generation system according to an embodiment of the present disclosure;

FIG. 3 is an exemplary flowchart of a method for generating a document according to an embodiment of the present disclosure;

FIG. 4 is a schematic diagram of an application scenario of a method for generating a document according to an embodiment of the present disclosure;

FIG. 5 is a schematic structural block diagram of an apparatus for generating a document according to an embodiment of the present disclosure; and

FIG. 6 is a schematic structural block diagram of an electronic device according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

With the advent of the information age, the writing of technical documents has become a key link in enterprise innovation, product development and project delivery. The rapid development of science and technology and the continuous specialization of professional fields have further intensified the market's urgent demand for high-quality technical documents. Currently, the professional, accurate and standardized technical content is required to support technological innovation and commercial applications regardless of technical solution design, system architecture description or project delivery document. However, traditional manual writing methods are limited by low efficiency, unstable quality and high dependence on individual expertise; and are difficult to meet this requirement, and cannot fulfill the dual expectations of modern enterprises for document quality and delivery speed.

In this context, with the rapid development of artificial intelligence technology, natural language processing and intelligent writing based on intelligent document generation systems have made some progress. However, when faced with the need to generate technical documents, traditional intelligent document generation systems still face fundamental challenges in terms of professionalism, logical rigor and quality consistency, making it difficult to achieve the high-quality automated generation.

Specifically, current mainstream intelligent document generation systems mainly rely on the following three technical paths, but each has its own limitations:

### Scheme 1: End-to-end generation based on a single model

Implementation principle: Based on a pre-trained model such as Generative Pre-trained Transformer (GPT), language patterns are learned by an encoder-decoder architecture through massive amounts of text data, to generate a technical document through an autoregressive approach after receiving a document generation request input by a user.

Limitations: Although the knowledge breadth of the pre-trained model is large, the pre-trained model lacks sufficient professional depth and struggles to accurately grasp complex technical logic and domain terms; and it is prone to problems such as unstable output, contradiction and inconsistent terms when generating a long document due to the limited length of a single generation, without effective quality control.

### Scheme 2: Structured filling based on templates and rules

Implementation principle: The intelligent document generation system pre-designs corresponding structural templates for various document types, including chapter structure, content element, format specification, etc. After receiving a document generation request input by a user, the key information and structured data are extracted from the request, and a matching structure template is determined. The extracted key information and structured data are filled into the corresponding positions in the matching structure template to generate a technical document.

Limitations: The generation of technical documents relies heavily on preset structure templates, resulting in poor flexibility and innovation; when facing new scenarios, the scalability is insufficient, requiring manual supplementation of structure templates, making it difficult to adapt to rapidly changing service requirements.

### Scheme 3: Distributed document processing system based on cloud collaboration environment

Implementation principle: The distributed document processing system provides a cloud workbench that integrates editing, retrieval and collaboration tools, supporting users' online collaborative creation and resource sharing behaviors to complete the generation of technical documents.

Limitations: The distributed document processing system essentially provide a combination of tool modules and process support, rather than true intelligent document generation; the system's document generation capability is limited by the integrated tool modules, lacking in-depth understanding and autonomous creation capabilities, and making it difficult to automatically produce high-quality technical documents.

In summary, the limitations of the above-mentioned intelligent document generation systems are as follows:
(1) Insufficient professional depth and credibility: The technical documents generated in Scheme 1 and Scheme 2 often fail to meet professional requirements in terms of technical accuracy, innovation and logical rigor, so the output quality of technical documents cannot be guaranteed.
(2) Poor quality controllability and consistency: This is especially evident in Scheme 1. Due to the lack of a quality control node that runs through the whole, the output quality fluctuates greatly. It is difficult to unify the style, terminology and logic within long documents, which will also have a negative impact on the output quality of technical documents.
(3) Limited system flexibility and scalability: The rigid architectures of Scheme 2 and Scheme 3 make it difficult to quickly adapt to unforeseen document types or in-depth customization requirements in specific fields, resulting in high evolution costs.

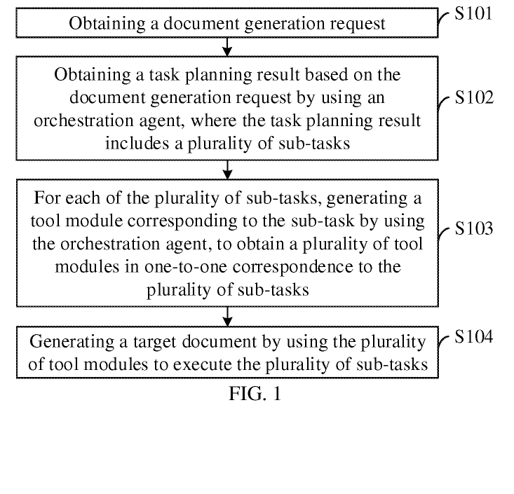

To solve at least some of the above problems, an embodiment of the present disclosure provides a method for generating a document, which can be applied to an electronic device. Here, the electronic device may be a server or a terminal device, Here, the terminal device may be a workbench, a mainframe computer, a conventional computer (e.g., a desktop computer), or other similar computing device. Hereinafter, a method for generating a document according to an embodiment of the present disclosure will be described in combination with the schematic flowchart shown in FIG. 1. It should be noted that a logical sequence is shown in the schematic flowchart, but the steps shown or described in the flowchart may also be performed in other sequences in some cases.

Step S101: obtaining a document generation request.

Here, the document generation request may carry document generation requirements and reference content.

In the embodiment of the present disclosure, the document generation requirements may include a generation requirement for document type (e.g., which document type needs to be generated, such as technical solution, system architecture description, project delivery document, etc.), and a generation requirement for document format (e.g., font size, color scheme, layout style, output format, etc.), constraints, etc.; and the reference content may be a document draft, a set of data, or other content that can provide original materials for the target document to be generated.

Step S102: obtaining a task planning result based on the document generation request by using an orchestration agent.

In the embodiment of the present disclosure, the "agent" can be understood as an autonomous task execution entity with role definition and specific goal, and belongs to a reasoning and decision-making engine that relies on a large underlying strategy model as core. Here, the large underlying strategy model may be, but is not limited to, a Large Language Model (LLM). Here, the LLM may be a pre-trained neural network model (e.g., an autoregressive generative model with Transformer architecture) that possesses a wealth of internal knowledge, such as language knowledge, world knowledge, and professional knowledge in various fields.

Furthermore, it should be noted that, in the embodiment of the present disclosure, the orchestration agent (also referred to as the "meta-agent") is an agent with a long lifespan in the intelligent document generation system, and can have the capabilities of request parsing, task planning, tool module generation and global state management. For example, in the embodiment of the present disclosure, the orchestration agent may parse the document generation request to obtain a request parsing result, and perform task planning based on the request parsing result to obtain the task planning result. Specifically, the orchestration agent may parse the document generation requirements carried by the document generation request to obtain the request parsing result, and perform task planning based on the request parsing result to obtain the task planning result. Here, the task planning result may include a plurality of sub-tasks, and the plurality of sub-tasks have a clear execution order. Here, the plurality of sub-tasks may include at least one of: input parsing task, research and analysis task, outline generation task, content writing task, chart generation task, or document merging task.

Step S103: for each of the plurality of sub-tasks, generating a tool module corresponding to the sub-task by using the orchestration agent, to obtain a plurality of tool modules in one-to-one correspondence to the plurality of sub-tasks.

In the embodiment of the present disclosure, for each of the plurality of sub-tasks, the corresponding tool module may be a sub-agent, a code tool, or both a sub-agent and a code tool. Here, the sub-agent can perform related processing of the sub-task based on the massive internal knowledge; and the code tool can perform related processing of the sub-task through pre-written code segments. Here, the code tool may be used to execute a sub-task, or may be invoked by the sub-agent while the sub-agent executes the sub-task.

Step S104: generating a target document by using the plurality of tool modules to execute the plurality of sub-tasks.

In the embodiment of the present disclosure, the orchestration agent can generate the target document by calling the plurality of tool modules to execute the plurality of sub-tasks. Specifically, the orchestration agent may call the plurality of tool modules to execute the plurality of sub-tasks in the execution order of the plurality of sub-tasks, to generate the target document.

With the method for generating the document provided in the embodiment of the present disclosure, the document generation request may be obtained, and the task planning result (the task planning result includes a plurality of sub-tasks) is obtained based on the document generation request by using the orchestration agent; then, for each of the plurality of sub-tasks, the tool module corresponding to the sub-task is generated by using the orchestration agent, to obtain a plurality of tool modules in one-to-one correspondence to the plurality of sub-tasks; and the target document is generated by using the plurality of tool modules to execute the plurality of sub-tasks. In other words, in the embodiment of the present disclosure, the document generation request is dynamically decomposed and planned by the orchestration agent to obtain the task planning result including the plurality of sub-tasks, and for each of the plurality of sub-tasks, the dedicated tool module corresponding thereto is generated in real time to execute the sub-task. This "on-demand generation and precise configuration" mechanism provides the customized professional processing capability for each sub-task, ensuring the technical accuracy, logical rigor and consistency of the target document, and thus improving the output quality of the target document; meanwhile, based on the mechanism of dynamically generating tool modules, the intelligent document generation system does not rely on pre-solidified structural templates or tool modules, and possesses the strong flexibility and scalability to handle complex document generation requirements and quickly adapt to new scenarios, thus significantly improving the efficiency of the automatic generation of the target document under the premise of ensuring the high output quality of the target document, and simultaneously expanding the application scope of the intelligent document generation system.

In some optional implementations, "generating a tool module corresponding to the sub-task" in step S103 may include: determining a tool type corresponding to the sub-task; when the tool type corresponding to the sub-task includes the agent type, generating a sub-agent corresponding to the sub-task as the tool module; and/or, when the tool type corresponding to the sub-task includes the code type, generating a code tool corresponding to the sub-task as the tool module.

Here, the tool type corresponding to the sub-task may include at least one of the agent type or the code type.

For example, when the tool type corresponding to the sub-task only includes the agent type, a sub-agent corresponding to the sub-task may be generated as the tool module; for another example, when the tool type corresponding to the sub-task only includes the code type, a code tool corresponding to the sub-task may be generated as the tool module; for yet another example, when the tool type corresponding to the sub-task includes both the agent type and the code type, a sub-agent corresponding to the sub-task and a code tool corresponding to the sub-task may be generated together as the tool module.

Furthermore, as mentioned above, in the embodiment of the present disclosure, the task planning result may include a plurality of sub-tasks, and the plurality of sub-tasks have a clear execution order. In this regard, in the embodiment of the present disclosure, the description information of each of the plurality of sub-tasks may also be generated in the task planning result, that is, the task planning result may also include the description information of each of the plurality of sub-tasks.

Here, the description information may include the input description, output description and execution condition description of the sub-task, so as to cover the basic functional requirements of the sub-task and explain the expected output result of the sub-task. In one example, the input description may include the type, format and source of the input data; the output description may specify the expected output result; and the execution condition description may include preconditions required for execution of the sub-task, such as system environment, resource usage, etc. Such description information can not only provide comprehensive and accurate guidance for subsequent generation of corresponding tool modules, but also ensure that the generated sub-agents or code tools complete their respective sub-tasks accurately and flawlessly, enabling the sub-agents or code tools to collaborate efficiently throughout the task chain, thereby ensuring the efficiency, accuracy and consistency of the entire generation process of the target document.

Based on the above, in an embodiment of the present disclosure, "determining a tool type corresponding to the sub-task" may include: obtaining description information of the sub-task; when determining based on the description information of the sub-task that execution of the sub-task requires cognitive and decision-making abilities, determining the agent type as the tool type corresponding to the sub-task; and/or, when determining based on the description information of the sub-task that execution of the sub-task involves a predefined external operation process, determining the code type as the tool type corresponding to the sub-task.

Here, the cognitive and decision-making abilities may be abilities to understand, analyze and reason about input data, and make reasonable judgments and decisions based on these processing results; and the predefined external operation process may include calling a retrieval interface, executing a specific algorithm, accessing an internal system, etc.

Through the above approach, the distinction of "tool type" (agent type and/or code type) may be introduced so that the intelligent document generation system can accurately match the most effective implementation method according to the inherent requirement of the sub-task (e.g., whether the sub-task requires cognition and decision-making or deterministic functional operation) in the embodiment of the present disclosure. This dynamic selection mechanism can fully leverage the advantages of the agent in understanding complex problems and creative work, and simultaneously make full use of the efficiency and reliability of code tools in executing deterministic and high-precision external operation processes, thereby achieving the optimal allocation of tool resources and maximizing the task execution efficiency throughout the entire generation process of the target document.

Moreover, in the embodiment of the present disclosure, when determining the tool type corresponding to the sub-task, the essential nature of the capability requirement is accurately identified by analyzing the description information of the sub-task, thereby achieving accurate automatic mapping from the sub-task description to the technical implementation form. This can not only effectively reduce reliance on predefined rules and significantly improve the intelligence and adaptability of the document generation system, but also ensure that the generated tool modules (whether sub-agents or code tools) accurately match the specific goals of the sub-tasks, ensuring the effectiveness and professionalism of subsequent execution links from the source.

Further, in an embodiment of the present disclosure, "generating a sub-agent corresponding to the sub-task" may include: obtaining description information of the sub-task; generating an agent definition based on the description information of the sub-task; and generating the sub-agent corresponding to the sub-task based on the agent definition.

Here, the agent definition includes at least one of:

Role description: the role definition of the sub-agent (that is, the definition of the agent's identity) and the definition of specific goals (that is, the definition of the type of task that the sub-agent needs to perform), such as "technical document polishing expert", "patent searcher", "outline generation proxy", etc., which determine the professional perspective and thinking mode of the sub-agent;

Capability boundary: define the "work permission" and "scope of vision" of the sub-agent to clarify what the sub-agent can do (e.g., which code tools the sub-agent can call) and what information the sub-agent can see (e.g., the sub-agent can only process the data of the chapter it is responsible for), to prevent overstepping of authority or information overload;

First data structure definition: specify the standard "data interface" of the sub-agent, that is, clearly define what format of input data the sub-agent can receive and what format of result the sub-agent must output, to ensure seamless integration between different tool modules;

Normative requirement: the built-in "quality checklist", used to characterize the format, terminology, style, and minimum quality standard that the sub-agent must follow, so as to ensure that the output result of the sub-agent conforms to the uniform requirement of the final target document from the beginning; or

Interaction rule: set the "collaboration rule" for sub-agents among the plurality of tool modules, and specifically, clarify who the sub-agent needs to wait for to complete work (dependency) and how the sub-agent communicates with other tool modules (interaction protocol).

In the embodiment of the present disclosure, after obtaining the description information of the sub-task and generating the agent definition based on the description information of the sub-task, the large underlying strategy model can be instantiated based on the agent definition to obtain an agent instance as the sub-agent corresponding to the sub-task, and the state thereof is marked as "registered" in the agent registration center. This sub-agent is logically independent of other sub-agents and is uniformly scheduled by the orchestration agent.

Through the above approach, the standardized and automated definition and generation of sub-agents can be achieved in the embodiment of the present disclosure. Specifically, in the embodiment of the present disclosure, it can be ensured that each sub-agent has clear and definite boundaries of responsibility and behavioral guidelines by generating the structured agent definition (including at least one of role description, capability boundary, first data structure definition, normative requirement or interaction rule). This can not only enable the generated sub-agents to be highly specialized, but also establish clear contracts for collaborative work among the sub-agents, greatly reducing the complexity of communication and collaboration among the sub-agents, and ensuring the orderly and efficient operation of the complex document generation task flow.

In an embodiment of the present disclosure, "generating a code tool corresponding to the sub-task" may include: obtaining description information of the sub-task; generating a code definition based on the description information of the sub-task; and generating the code tool corresponding to the sub-task based on the code definition.

Here, the code definition may include at least one of:

Function signature: "call format" of the code tool, which may include a function name and a parameter list to define how to call this code tool.

Second data structure definition: specify the standard "data interface" of the code tool, that is, clearly define what format of input data the code tool can receive and what format of result the code tool must output, to ensure seamless integration between different tool modules.

In the embodiment of the present disclosure, after generating the code tool corresponding to the sub-task based on the code definition, the code tool may be registered in the corresponding runtime environment for use by some tool modules (e.g., sub-agents).

In one example, "generating the code tool corresponding to the sub-task based on the code definition" may include: generating a code segment based on the code definition; testing the code segment to obtain a test result; and when the test result indicates that the code segment is available, generating the code tool corresponding to the sub-task based on the code segment.

Here, the code segment may be, but is not limited to, a utility function (e.g., Python function), an Application Programming Interface (API) encapsulated module or a script program, which encapsulates the functional logic required to implement the sub-task; the automatic writing implementation logic of the code segment may include Hyper Text Transfer Protocol (HTTP) request, database query, algorithm calculation, file reading and writing, etc.

In the embodiment of the present disclosure, after generating the code segment based on the code definition, the orchestration agent may be used to construct test cases for testing the code segment to obtain a test result. These test cases may be integrated into an automatically executable test script. The code segment is run in the test environment, and the actual output result is compared with the expected output result to obtain the test result. For example, if the actual output result is consistent with the expected output result, a test result characterizing the usability of the code segment is obtained; if the actual output result is not consistent with the expected output result, a test result characterizing the un-usability of the code segment is obtained.

Through the above approach, a solid foundation can be laid for the automatic generation of the code tool by pre-generating the code definition including the function signature and second data structure definition in the embodiment of the present disclosure. Here, the function signature implements a standardized declaration of the code tool; and the second data structure definition ensures that the internal logic of the code tool can correctly process the formatted input data. This approach results in the code tool with the clear interface and safe type that is easy to integrate and invoke, thus significantly improving the usability, reliability and interoperability of the code tool with other tool modules.

Moreover, in the embodiment of the present disclosure, a post-generation verification step is also introduced when generating the code tool corresponding to the sub-task based on the code definition. Specifically, code segments with syntax errors, logical flaws or runtime exceptions may be effectively intercepted by automatically generating test cases and testing the generated code segments, so that only the code segments passing the test will be used to generate the code tools corresponding to the sub-tasks and put into use, so as to avoid the participation of defective code tools that may lead to the failure of the document generation task flow, and improve the success rate of generating the target document.

In some optional implementations, step S104 of "generating a target document by using the plurality of tool modules to execute the plurality of sub-tasks" may include: determining a current module from the plurality of tool modules according to an execution order of the plurality of sub-tasks; determining a current task corresponding to the current module from the plurality of sub-tasks; executing the current task by invoking the current module to obtain an intermediate result; and generating the target document based on the intermediate result.

In the embodiment of the present disclosure, when the current module is invoked to execute the current task, the dependency may be the reference content carried by the document generation request or the output result of another tool model (at this time, the current module and the other tool module have a dependency relationship; specifically, the execution of the current module needs to depend on the output result of the other tool module).

In one example, "executing the current task by invoking the current module to obtain an intermediate result" may include: executing the current task by invoking the current module to obtain an initial result; determining a unified data format requirement; and performing format conversion on the initial result according to the unified data format requirement to obtain the intermediate result.

Here, the unified data format requirement may be either a first lightweight markup language format (JavaScript Object Notation, JSON) or a second lightweight markup language format (e.g., Markdown), which is not limited in the embodiment of the present disclosure.

Furthermore, it should be noted that the intermediate result may be stored in the data management layer of the intelligent document generation system via a data bus in the embodiment of the present disclosure. Based on this, in the embodiment of the present disclosure, when all intermediate results required to generate the target document are obtained and these intermediate results are merged to obtain the target document, a document merging proxy (belonging to a sub-agent) may be invoked to read these intermediate results from the data management layer and merge these intermediate results to obtain the target document.

Through the above approach, the embodiment of the present disclosure clarifies that the driving logic of the intelligent document generation system is based on the serial or controlled parallel execution planned by the orchestration agent. This "proceed step by step as planned" approach ensures that the intelligent document generation system has strict logic and timing, and is particularly suitable for task flows like document generation where there is a strong dependency between preceding and subsequent stages. This approach avoids the chaos of task execution, so that output results of upstream tool modules can be transmitted to downstream tool modules as clear and reliable input data, ensuring the orderly and accurate transmission of intermediate results in the processing chain, and providing key process assurance for ultimately generating the logically-coherent and content-complete target document.

Furthermore, in the embodiment of the present disclosure, when executing the current task by invoking the current module to obtain the intermediate result, the universal data exchange language within the intelligent document generation system is established by forcibly implementing the unified data format requirement (e.g., JSON, Markdown, etc.). In this way, the problem of heterogeneous data formats that may arise between different tool modules can be solved, and the standardization of intermediate results in form can be achieved. The standardized intermediate results are not only easy for downstream tool modules to parse and use accurately, but also greatly facilitate the orchestration agent in monitoring the document generation task flow, checking the data consistency and rearranging tasks, thereby further improving the final generation quality of the target document.

Further, the method for generating the document provided in the embodiment of the present disclosure may further include: performing quality detection on the target document to obtain a detection result; and when the detection result indicates that the target document is available, destroying the plurality of tool modules.

Here, the detection result may be a quality score in the numerical range 0, 1.

Based on this, in the embodiment of the present disclosure, if the detection result is less than a preset score threshold, the target document is determined to be unavailable, and a new document generation task flow is executed to obtain a new target document; if the detection result is greater than or equal to the preset score threshold, the target document is determined to be available. Here, the preset score threshold may be set according to application requirements, and is not limited in the embodiment of the present disclosure.

Furthermore, it should be noted that the quality detection may be performed on the target document from multiple detection dimensions in the embodiment of the present disclosure. Here, the multiple detection dimensions may be determined based on the document type of the target document to be generated. For example, when the document type of the target document to be generated is technical solution, the multiple detection dimensions may include:

Completeness of input source utilization: detect whether the target document includes all reference content;

Technical accuracy: detect whether the use of core terms is consistent, whether the technical parameters and logical descriptions are accurate, and whether there is any contradiction with authoritative materials retrieved;

Structure and completeness: detect whether the target document fully follows the outline structure output by the outline generation replacement (belonging to the sub-agent); whether all required chapters, charts and references are complete; and whether there is any missing or redundant content;

Format and normalization: detect whether the output format of the target document is in accordance with the generation requirement of the document format provided by the document generation requirement, and conforms to the relevant type standard of the relevant target document; and

Language and readability: assess the fluency of the target document, the appropriateness of professional terms, and the presence of ambiguity or grammatical errors through natural language processing techniques.

Here, each detection dimension will have a corresponding individual detection score, that is, multiple individual detection scores in one-to-one correspondence to the multiple detection dimensions can be obtained. Based on this, in the embodiment of the present disclosure, the multiple individual detection scores may be weighted to obtain the detection result when the multiple individual detection scores meet respective minimum individual score requirements. For each of the multiple individual detection scores, the corresponding minimum individual score requirement may be set according to application requirements, and is not limited in the embodiment of the present disclosure.

In the embodiment of the present disclosure, the plurality of tool modules can be destroyed when the detection results indicate that the target document is available. Here, "destroying the plurality of tool modules" can be seen as a systematic resource recycling and cleanup process, which is initiated and monitored by the orchestration agent. The specifically process may include:

Deregistration of sub-agent: for a sub-agent, the intelligent document generation system may send a termination command to the sub-agent to end its background process or session, mark its state as "destroyed" in the agent registry center, and release the model computing resource and context memory occupied by the sub-agent;

Execution of environment cleanup: for a code tool, the intelligent documentation generation system may remove the definition of the code tool from its registered runtime environment, and dereference the code tool, enabling the memory to be recycled by the garbage recycling mechanism; and simultaneously clean up temporary files or caches that may be generated during operation; and

Permission and interface recycling: simultaneously unbind the permissions and interfaces of the plurality of tool modules that are invoked within the intelligent document generation system to ensure that subsequent tasks will not incorrectly invoke the destroyed tool modules.

Through the above approach, the embodiment of the present disclosure can achieve closed-loop management of the task life cycle, take into account the elegant release of resources of the intelligent document generation system while providing quality assurance for the final generated target document, reflect the resource management awareness of the intelligent document generation system, avoid the resource leakage caused by temporarily-generated and task-specific computing entities remaining in memory permanently, enhance the data security, and ensure that the intelligent document generation system can operate stably and efficiently for a long time; and is always ready to handle new document generation requests, and has good engineering practice value. Moreover, the quality detection step for the target document is introduced before the plurality of tool modules are destroyed, to ensure that the final produced target document meets the preset standards, improve the direct availability of the target document and reduce the cost of manual review.

Hereinafter, the method for generating the document provided in the embodiments of the present disclosure will be further illustrated in three sections.

### I. Overview of Solution

The intelligent document generation system, with an orchestration agent (also known as a meta-agent) as core, completes the entire process from a document generation request to outputting a target document through the dynamic generation, configuration and orchestration of a plurality of tool modules (including sub-agents and code tools).

Core idea: at the engineering implementation level, only one orchestration agent with a long lifespan (i.e., always existing) is retained, and other sub-agents and code tools are automatically generated, registered and destroyed by the orchestration agent on demand at runtime. In other words, the intelligent document generation system is logically manifested as multi-agent collaboration, but in essence, is an "evolvable multi-agent system driven by the orchestration agent".

Basic process:
(1) Obtaining a document generation request sent by a user.
(2) The orchestration agent parses the document generation request to obtain a request parsing result, and performs task planning based on the request parsing result to obtain a task planning result (i.e., an orchestration plan), including a plurality of sub-tasks which have a clear execution order.
(3) The orchestration agent automatically generates a plurality of tool modules in one-to-one correspondence to the plurality of sub-tasks based on the task planning result. Here, the plurality of tool modules may include sub-agents and/or code tools, and the plurality of tool module has their own goals and dependencies. Here, the code tool may be used to execute a sub-task, or may be invoked by the sub-agent while the sub-agent executes the sub-task.
(4) The orchestration agent coordinates the execution order and concurrency of the plurality of tool modules according to the clear execution order of the plurality of sub-tasks, manages the formats and states of intermediate results in a unified manner, and drives each tool module to complete the input parsing, technical research, outline design, content writing, chart generation, document merging and other links.
(5) The orchestration agent performs quality detections and adjustments on the intermediate results and the target document based on a preset quality detection strategy to ensure that the final generated target document meets the target format and quality requirements.

Through the above design, the embodiment of the present disclosure can introduce the capabilities of "multi-tool module orchestration" and "multi-tool module generation" without increasing the number of underlying models, making the intelligent document generation system significantly superior to traditional solutions in terms of professional depth, flexibility and scalability.

Core technical features:

(1) Orchestration architecture of tool modules with the orchestration agent as core the embodiment of the present disclosure introduces a long-lifecycle orchestration agent that has the capabilities of request parsing, task planning, tool module generation and global state management. The core responsibilities thereof include: parse the document generation request sent by the user, that is, perform task-level understanding and decomposition; plan the collaborative topology (including execution order, parallel relationship and dependency relationship) of the plurality of sub-tasks (i.e., the plurality of tool modules); define the responsibilities, input/output contracts and constraints of the sub-agents; determine the invocation strategy of the code tools and how the code tools are bound to the sub-agents; and monitor the execution progress and output quality of the tool modules uniformly, and perform dynamic re-orchestration when necessary.

In the embodiment of the present disclosure, the orchestration agent is not only responsible for scheduling, but also for "defining" and "evolving" the plurality of tool modules, realizing the upgrade from "multi-agent collaboration" to "orchestration of tool modules (including sub-agents)".

(2) Automatic generation mechanism of sub-agents and code tools (driven by the orchestration agent and implemented based on codes)

Key point: the orchestration agent automatically generates sub-agents and code tools at runtime, rather than relying on manual pre-writing and static registration. The process specifically includes:

Generation of sub-agent:

The orchestration agent generates a corresponding sub-agent for a sub-task to be executed by the sub-agent based on the task planning result, and specifically, may obtain the description information of the sub-task, generate an agent definition based on the description information of the sub-task, and then generate the sub-agent corresponding to the sub-task based on the agent definition. Here, the agent definition includes at least one of:

Role description: the role definition of the sub-agent (that is, the definition of the agent's identity) and the definition of specific goals (that is, the definition of the type of task that the sub-agent needs to perform), such as "technical document polishing expert", "patent searcher", "outline generation proxy", etc., which determine the professional perspective and thinking mode of the sub-agent;

Capability boundary: define the "work permission" and "scope of vision" of the sub-agent to clarify what the sub-agent can do (e.g., which code tools the sub-agent can call) and what information the sub-agent can see (e.g., the sub-agent can only process the data of the chapter it is responsible for), to prevent overstepping of authority or information overload;

First data structure definition: specify the standard "data interface" of the sub-agent, that is, clearly define what format of input data the sub-agent can receive and what format of result the sub-agent must output, to ensure seamless integration between different tool modules;

Normative requirement: the built-in "quality checklist", used to characterize the format, terminology, style, and minimum quality standard that the sub-agent must follow, so as to ensure that the output result of the sub-agent conforms to the uniform requirement of the final target document from the beginning; or

Interaction rule: set the "collaboration rule" for sub-agents among the plurality of tool modules, and specifically, clarify who the sub-agent needs to wait for to complete work (dependency) and how the sub-agent communicates with other tool modules (interaction protocol).

After obtaining the description information of the sub-task and generating the agent definition based on the description information of the sub-task, the large underlying strategy model can be instantiated based on the agent definition to obtain an agent instance as the sub-agent corresponding to the sub-task, and the state thereof is marked as "registered" in the agent registration center. This sub-agent is logically independent of other sub-agents and is uniformly scheduled by the orchestration agent.

Generation of code tool:

The orchestration agent generates a corresponding code tool for a sub-task involving a predefined external operation process based on the task planning result, and specifically, may obtain the description information of the sub-task, generate a code definition based on the description information of the sub-task, generate a code segment based on the code definition, test the code segment to obtain a test result, and generate the code tool corresponding to the sub-task based on the code segment when the test result indicates that the code segment is available. Here, the code definition includes at least one of:

Here, the code definition may include at least one of:

Function signature: "call format" of the code tool, which may include a function name and a parameter list to define how to call this code tool.

Second data structure definition: specify the standard "data interface" of the code tool, that is, clearly define what format of input data the code tool can receive and what format of result the code tool must output, to ensure seamless integration between different tool modules.

After generating the code tool corresponding to the sub-task based on the code definition, the code tool may be registered in the corresponding runtime environment for use by some tool modules (e.g., sub-agents).

Through the above design, in the embodiment of the present disclosure, the technical implementation is "only one orchestration agent + a set of automatically generated sub-agents and/or tool codes", which essentially realizes the construction of a bootstrap multi-tool module system.

(3) Standardized orchestration process and structured data transmission mechanism

Based on multi-tool module orchestration, the HIA in the embodiment of the present disclosure defines a unified orchestration process and data interface specification, including:

Multi-stage orchestration process: parsing a document generation request, task planning, generation and registration of sub-agents, generation and registration of code tools, collaborative execution, quality detection and delivery, etc.;

Unified intermediate result model: use a unified data format requirement (e.g., JSON, Markdown, etc.) to output intermediate results, such as technical elements, literature analysis result, outline structure, paragraph content, figure and chart description, etc.; and

Central "data bus" mechanism: all tool modules may read and write intermediate results at the data management layer through the standardized data structure, and the orchestration agent is responsible for consistency maintenance and version management.

Unlike the "point-to-point data transmission" in traditional solutions, the embodiment of the present disclosure improves the efficiency and traceability of data transmission under the orchestration of multiple tool modules by superimposing the "unified intermediate result model" with the "central "data bus" mechanism".

### II. Detailed Explanation of Solution

### Intelligent Proxy Architecture Design

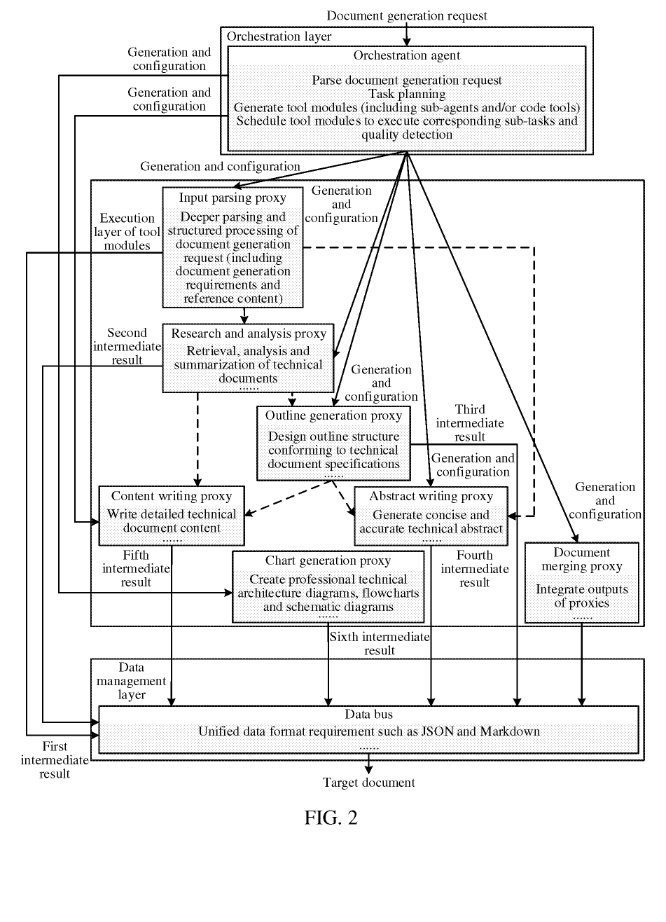

Referring to FIG. 2, in the embodiment of the present disclosure, the intelligent document generation system includes an orchestration agent.

In one example, the sub-agents dynamically instantiated by the orchestration agent include an input parsing proxy, a research and analysis proxy, an outline generation proxy, an abstract writing proxy, a content writing proxy, a chart generation proxy, and a document merging proxy.

Here, the orchestration agent is the core component of the intelligent document generation system, and has a global perspective and self-description capability. The main functions include parsing the document generation request, task planning, generating a plurality of tool modules (including sub-agents and/or code tools), scheduling tool modules to execute corresponding sub-tasks, and quality detection. The details can refer to the relevant descriptions above, and will not be repeated here.

Exemplarily, the plurality of tool modules include the following sub-agents:

(1) Input parsing proxy

The input parsing proxy is automatically generated by the orchestration agent, and the definition thereof (agent definition) and the code tool to be invoked are configured by the orchestration agent.

The input parsing proxy is the entrance to the entire intelligent document generation system, and is responsible for performing deeper parsing and structured processing of the document generation request (including document generation requirements and reference content) provided by the user. The input parsing proxy employs multi-layered text analysis techniques, including syntax analysis, semantic understanding, entity recognition, relation extraction and other advanced technical means, to extract the key technical information from the reference content. Specifically, the input parsing proxy uses the first deep learning model (hereinafter referred to as the understanding model) to identify core elements such as technical concepts, innovations, application scenarios and technical advantages, and constructs a complete technical information graph.

The core processing flow of the input parsing proxy includes: preprocessing the document generation requirement and reference content, including text cleaning, format standardization, language detection and other basic operations; using an encoder model (for example, an encoder model with Transformer architecture) to conduct in-depth semantic understanding of the document generation requirement and reference content, to identify the technical entities and concepts therein; establishing a logical relationship between technical concepts through a relation extraction algorithm, and constructing a technical knowledge graph as a parsing result; and structurally storing the parsing result according to a predefined data model, and generating a standardized first intermediate result, which is stored in the data management layer to provide a basis for subsequent processing by other proxies.

Furthermore, in the embodiment of the present disclosure, the input parsing proxy is designed with a customized understanding model tailored to the characteristics of technical documents. This understanding model is pre-trained on large-scale technical document data and has powerful technical concept recognition and professional understanding capabilities. At the same time, the input parsing proxy also integrates an adaptive learning mechanism, which can continuously optimize the understanding effect based on user feedback.

(2) Research and analysis proxy

The research and analysis proxy is automatically generated by the orchestration agent, and the definition thereof (agent definition) and the code tool to be invoked are configured by the orchestration agent.

The research and analysis proxy focuses on the retrieval, analysis and summarization of relevant technical documents, and provides the professional technical background and theoretical support for the generation of the target document, serving as a second intermediate result. The research and analysis proxy integrates multiple search engines and professional database interfaces, and can automatically retrieve relevant patent documents, academic papers, technical reports, industry standards and other materials based on the first intermediate result provided by the input parsing proxy. During the search process, the comprehensiveness and accuracy of the search result can be ensured through intelligent keyword expansion and semantic matching technology.

The core functions of the research and analysis proxy include: generation of intelligent retrieval strategies, document relevance analysis, and extraction of key technical points. In terms of generation of retrieval strategies, the research and analysis proxy can automatically construct multi-dimensional retrieval expressions based on the technical keywords obtained from input parsing, including synonym expansion, hyponym and hypernym retrieval, technical field limitation and other strategies; in terms of document relevance analysis, the research and analysis proxy can use a second deep learning model to score the semantic relevance of retrieved documents and select the most relevant materials with high quality; and in terms of extraction of technical points, the research and analysis proxy can extract the key technical information from relevant documents through the natural language processing technology, including technical principle, implementation method, application effect and other important content.

The technical feature of the research and analysis proxy lies in the establishment of an analysis model specialized for technical documents. This analysis model can accurately understand the professional content and logical structure of technical documents, and extract the most valuable information for document generation. Meanwhile, the research and analysis proxy can also support the processing of multilingual documents and cross-language information integration, and obtain the valuable information from technical resources worldwide.

(3) Outline generation proxy

The outline generation proxy is automatically generated by the orchestration agent, and the definition thereof (agent definition) and the code tool to be invoked are configured by the orchestration agent.

The outline generation proxy is responsible for designing the overall structural framework of the target document, ensuring that the logical hierarchy of the technical content is clear and the chapters are arranged reasonably. The outline generation proxy automatically designs an outline structure conforming to technical document specifications, based on the first intermediate file and the second intermediate result, as a third intermediate result. The outline generation proxy has a built-in template library for various document types, including standard templates for technical solution design, system architecture description and project delivery documents, and can select the most suitable document structure according to the technical characteristics. The design principles of the outline generation proxy include: logical integrity, hierarchy clarity, content balance, compliance with norms, etc. In terms of logical integrity, the outline generation proxy can ensure that the outline covers all important technical elements without omitting any key content; in terms of hierarchy clarity, the outline generation proxy can design a reasonable chapter hierarchy to ensure the orderly development of technical content; in terms of content balance, the outline generation proxy can reasonably allocate the content weight of each chapter, avoiding some chapters from being too long or too short; and in terms of compliance with norms, the outline generation proxy can strictly follow the standard formats and industry practices of relevant document types.

The technological innovation of the outline generation proxy lies in using a structural design algorithm based on a graph neural network, and this algorithm can analyze the logical relationships between technical elements and automatically generate the optimal document structure. The proxy also supports personalized customization function, allowing users to adjust the outline structure and content distribution according to specific requirements.

(4) Abstract writing proxy

The abstract writing proxy is automatically generated by the orchestration agent, and the definition thereof (agent definition) and the code tool to be invoked are configured by the orchestration agent.

The abstract writing proxy focuses on condensing the core content and innovative points of the technical document to generate a concise and accurate technical abstract. This proxy identifies the core points, main technical advantages and important application value of the reference content based on the first and second intermediate results, and uses the highly condensed language to generate a professional technical abstract as a fourth intermediate result. The abstract writing proxy places special emphasis on the professionalism, accuracy and conciseness of the abstract, ensuring that the core value of the technical solution is fully conveyed within a limited space.

The writing strategies of the abstract writing proxy include: the principle of prioritizing innovation points, the principle of clear technical logic, and the principle of standardized professional terminology, etc. In terms of prioritizing innovation points, the abstract writing proxy can highlight the innovativeness and breakthrough of the technical solution, and emphasize advantages over existing technologies; in terms of clear technical logic, the abstract writing proxy can ensure that the logical hierarchy of the abstract content is clear, facilitating readers to quickly understand the technical solution; and in terms of standardized professional terminology, the abstract writing proxy can use the standardized professional terminology to ensure the accuracy and professionalism of the expression.

The technical feature of the abstract writing proxy lies in the establishment of a dedicated technical abstract generation model, and this model is trained on a large amount of high-quality technical abstract data and has powerful content condensation and expression capabilities. At the same time, the abstract writing proxy also integrates a consistency check mechanism to ensure the consistency between the abstract content and the main text content.

(5) Content writing proxy

The content writing proxy is automatically generated by the orchestration agent, and the definition thereof (agent definition) and the code tool to be invoked are configured by the orchestration agent.

The content writing proxy is the core content generation module of the intelligent document generation system, responsible for writing the detailed content of the technical document based on the second and third intermediate results. The content writing proxy studies and analyzes the second and third intermediate results based on the technical information obtained from input parsing, to generates complete, professional and standardized technical document content as a fifth intermediate result. The content writing proxy places special emphasis on the accuracy, completeness and professionalism of the technical description, ensuring that the generated fifth intermediate result can meet the professional standards of technical documents.

The writing strategies of the content writing proxy include: expanding technical details, unfolding logical structures, unifying professional terminology, ensuring content quality, etc. In terms of expanding technical details, the content writing proxy can supplement the reference content provided by users with reasonable details based on technical logic and industry common sense, making the technical content more substantial and complete; in terms of unfolding logical structure, the content writing proxy can strictly follow the logical hierarchy designed in the outline to unfold the content, ensuring the organic connection between chapters; in terms of unifying professional terminology, the content writing proxy can ensure that the entire text uses consistent terminology to avoid confusion; and in terms of ensuring content quality, the content writing proxy can ensure the technical accuracy and logical consistency of the generated content through multiple verification mechanisms.

The content writing proxy is implemented based on a generation model specifically designed for technical documents, integrates natural language generation technologies and professional knowledge graphs deeply, and is capable of generating the technical content that is both professional and accurate as well as logically clear. The content writing proxy can also support the generation of various technical document types, including technical solution design, system architecture description, project delivery document, etc.

(6) Chart generation proxy

The chart generation proxy is automatically generated by the orchestration agent, and the definition thereof (agent definition) and the code tool to be invoked are configured by the orchestration agent.

The chart generation proxy is responsible for creating professional technical architecture diagrams, flowcharts and schematic diagrams, providing intuitive visualization support for the target document. The chart generation proxy automatically designs and generates corresponding technical charts (including system architecture diagrams, workflow diagrams, module relationship diagrams, data flow diagrams, and other types of diagrams) as the sixth intermediate content based on the fifth intermediate result. The chart generation proxy places special emphasis on the professionalism, clarity and aesthetics of the charts, ensuring that the generated charts accurately convey the architecture and processes of the technical solution.

The chart generation process of the chart generation proxy includes: chart type identification, chart structure design, graphic element drawing, and chart beautification and optimization. In terms of chart type identification, the chart generation proxy can automatically select the most suitable chart type based on the characteristics of the technical content; in terms of chart structure design, the chart generation proxy can design the reasonable chart layout and element arrangement; in terms of graphic element drawing, the chart generation proxy uses standardized graphic symbols and connecting lines to draw charts; and in terms of chart beautification and optimization, the chart generation proxy can adjust the color scheme, font and layout of charts to improve the the aesthetics and readability of charts.

The chart generation proxy can generate technical charts meeting professional standards by establishing a dedicated knowledge base for technical chart design containing a large number of standardized chart templates and design specifications. This proxy supports the chart output in the format of chart drawing language (e.g., Mermaid), facilitating direct use and editing in the target document (e.g., the target document in Markdown format).

(7) Document merging proxy

The document merging proxy is automatically generated by the orchestration agent, and the definition thereof (agent definition) and the code tool to be invoked are configured by the orchestration agent.

The document merging proxy is the final processing module of the intelligent document generation system, and is responsible for integrating the outputs of the proxies (i.e., all the intermediate results) to generate a complete target document. The document merging proxy receives the first intermediate result (the parsing result provided by the input parsing proxy), the second intermediate result (the technical background and theoretical support provided by the research and analysis proxy), the third intermediate result (the outline structure provided by the outline generation proxy), the fourth intermediate result (the technical abstract provided by the abstract writing proxy), the fifth intermediate result (the technical document content provided by the content writing proxy), and the sixth intermediate result (the technical charts provided by the chart generation proxy); and then integrates these intermediate results according to the autonomous or predefined templates and formats to generate the target document.

The merging process of the document merging proxy includes: content integration, format standardization, terminology unification, quality detection, and output optimization. In terms of content integration, the document merging proxy can organically integrate outputs of all modules according to the outline structure; in terms of format standardization, the document merging proxy can adjust the format according to the format requirement of the target document type; in terms of terminology unification, the document merging proxy can check and unify the professional terminology of the entire text; in terms of quality detection, the document merging proxy can perform multi-level quality verification, including checks on content integrity, logical consistency and format standardization; and in terms of output optimization, the document merging proxy can perform final optimization adjustments to documents, ensuring the professionalism and aesthetics of the output documents.

Since the document merging proxy establishes the dedicated quality control mechanism and terminology management system, the document merging proxy can effectively ensure the quality and consistency of the output documents. The document merging proxy can also support a variety of output formats (including Markdown, Word, PDF) to meet the requirements of different users.

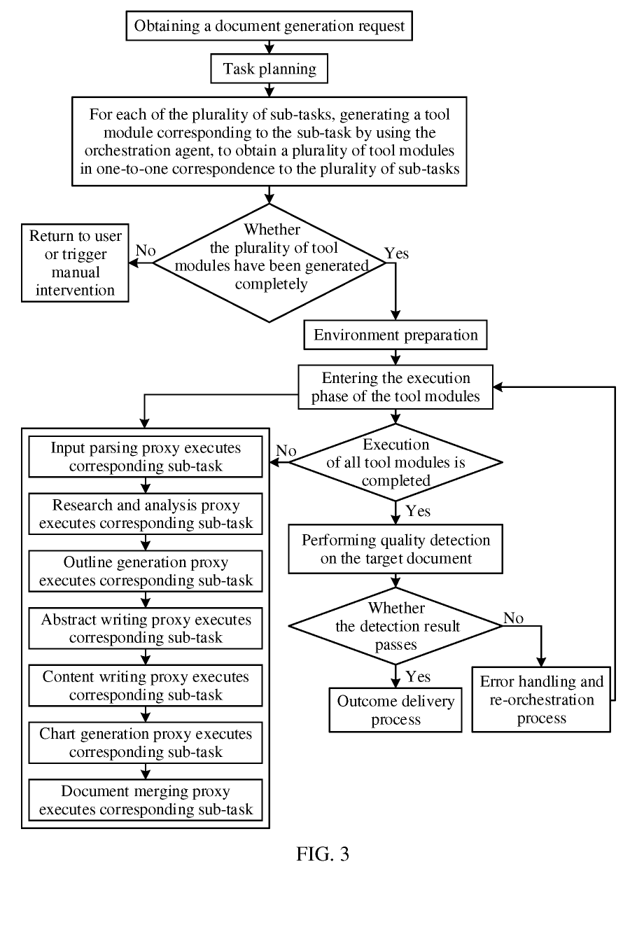

Referring to FIG. 3, the method for generating the document provided in the embodiment of the present disclosure may include the following relatively complete process:

(1) Obtaining a document generation request.

Here, the document generation request may carry document generation requirements and reference content.

(2) Task planning

A task planning result is obtained based on the document generation request by using an orchestration agent.

Here, the task planning result may include a plurality of sub-tasks, and the plurality of sub-tasks have a clear execution order.

(3) For each of the plurality of sub-tasks, generating a tool module corresponding to the sub-task by using the orchestration agent, to obtain a plurality of tool modules in one-to-one correspondence to the plurality of sub-tasks.

It is detected whether the plurality of tool modules have been generated completely. If the plurality of tool modules have been generated completely within the preset waiting time, enter process (4); if the plurality of tool modules have not been generated completely within the preset waiting time, return to the user or trigger manual intervention. Here, the preset waiting time may be set according to application requirements, and is not limited in the embodiment of the present disclosure.

(4) Environmental preparation

For example, job targets and logs are created, and the data bus and configuration files are initialized.

(5) Entering the execution phase of the tool modules

Exemplarily, the plurality of tool modules include an input parsing proxy, a research and analysis proxy, an outline generation proxy, an abstract writing proxy, a content writing proxy, a chart generation proxy, and a document merging proxy.

Here, the input parsing proxy is the entrance to the entire intelligent document generation system, and is responsible for performing deeper parsing and structured processing of the document generation request (including document generation requirements and reference content) provided by the user to obtain a first intermediate result.

The research and analysis proxy focuses on the retrieval, analysis and summarization of relevant technical documents, and provides the professional technical background and theoretical support for the generation of the target document, serving as a second intermediate result.

The outline generation proxy is responsible for designing the overall structural framework of the target document, ensuring that the logical hierarchy of the technical content is clear and the chapters are arranged reasonably. The outline generation proxy automatically designs an outline structure conforming to technical document specifications, based on the first intermediate file and the second intermediate result, as a third intermediate result.

The abstract writing proxy focuses on condensing the core content and innovative points of the technical document to generate a concise and accurate technical abstract. This proxy identifies the core points, main technical advantages and important application value of the reference content based on the first and second intermediate results, and uses the highly condensed language to generate a professional technical abstract as a fourth intermediate result.

The content writing proxy is the core content generation module of the intelligent document generation system, responsible for writing the detailed content of the technical document based on the second and third intermediate results. The content writing proxy studies and analyzes the second and third intermediate results based on the technical information obtained from input parsing, to generates complete, professional and standardized technical document content as a fifth intermediate result.

The chart generation proxy is responsible for creating professional technical architecture diagrams, flowcharts and schematic diagrams, providing intuitive visualization support for the target document. The chart generation proxy automatically designs and generates corresponding technical charts (including system architecture diagrams, workflow diagrams, module relationship diagrams, data flow diagrams, and other types of diagrams) as the sixth intermediate content based on the fifth intermediate result.

The document merging proxy is the final processing module of the intelligent document generation system, and is responsible for integrating the outputs of the proxies (i.e., all the intermediate results) to generate a complete target document. The document merging proxy receives the first intermediate result (the parsing result provided by the input parsing proxy), the second intermediate result (the technical background and theoretical support provided by the research and analysis proxy), the third intermediate result (the outline structure provided by the outline generation proxy), the fourth intermediate result (the technical abstract provided by the abstract writing proxy), the fifth intermediate result (the technical document content provided by the content writing proxy), and the sixth intermediate result (the technical charts provided by the chart generation proxy); and then integrates these intermediate results according to the autonomous or predefined templates and formats to generate the target document.

(6) Document detection

After the execution of the plurality of tool modules is completed, quality detection is performed on the target document to obtain a detection result.

Here, when the detection result passes, indicating that the target document is available, enter the outcome delivery process; when the detection result does not pass, indicating that the target document is unavailable, enter the error handling and re-orchestration process.

(7) Outcome delivery process

That is, the target document is output.

(8) Error handling and re-orchestration process

In the error handling and re-orchestration process, operations such as problem localization and analysis, re-definition or structural adjustment of sub-agents, and repair or re-generation of tool codes may be performed. These operations may be handled by the orchestration agent.

### III. Technical Effects

### Effect 1: Significantly improve the generation quality of the target document

Technical advantages:
The embodiments of the present disclosure achieve a significant improvement in the quality of technical documents through the division of labor and collaboration among specialized proxies. Each tool module (e.g., sub-agent) focuses on a specific processing link, ensuring that each intermediate result has sufficient professional depth and technical accuracy. Compared to the end-to-end generation method based on a single model in the traditional solution, specialized tool modules can achieve a higher level of expertise in their respective fields, thereby ensuring the overall generation quality of the target document.

Implementation:
The embodiments of the present disclosure solve the problem of unstable quality through the division of labor among specialized proxies. Specifically, the input parsing proxy is specially responsible for technical understanding to ensure the accurate interpretation of user input; the research and analysis proxy focuses on technical document retrieval to provide professional technical background and theoretical support; and the content writing proxy is specially responsible for generating technical content to ensure the accuracy and professionalism of technical description. Through this specialized division of labour, each processing link has reached an expert-level professional standard.

### Effect 2: Significantly improve the document generation efficiency

Technical advantages: The embodiments of the present disclosure achieve a significant improvement in document generation efficiency through the collaborative work of tool modules. Compared to the manual writing method in the traditional solution, the intelligent document generation system can complete the writing of technical documents that originally took days or even weeks in just a few hours while greatly reducing the need for manual intervention through the standardized process and automated processing, improving the overall work efficiency.

Implementation:
The embodiments of the present disclosure improve the document generation efficiency through parallel processing of multiple tool modules (e.g., sub-agents) and intelligent workflow management. The tool modules may work in parallel using the pipeline approach. For example, after the input parsing is completed, the research analysis and outline design may be carried out in parallel, and the content writing and chart generation may also be carried out in parallel. The intelligent document generation system also integrates an intelligent progress management and error handling mechanism, which can automatically monitor the execution state of each tool module, promptly detect and handle problems, and avoid the workload of manual monitoring.

### Effect 3: Ensure document format standardization

Technical advantages:
The embodiments of the present disclosure can ensure the format standardization and structural rationality of the generated documents through standardized templates and specification processing. The intelligent document generation system has built-in standard templates for various technical document types, and strictly follows industry standards and format requirements to ensure that the generated documents meet the standards of formal documents.

Implementation:
The embodiments of the present disclosure ensure the standardization of documents through template-driven and format normalization. The outline generation proxy designs document structures based on standard templates to ensure that the chapter division and content arrangement conform to specifications; and the document merging proxy performs format standardization and normalization, including the standardization of title format, paragraph indentation, figure and table numbering, references and other elements. The intelligent document generation system also integrates an automated format checking mechanism to ensure that the output documents fully comply with predefined format standards.

### Effect 4: Support intelligent content expansion

Technical advantages:
The embodiments of the present disclosure can generate detailed and complete technical documents based on concise technical descriptions provided by users through an intelligent content understanding and expansion mechanism. The intelligent document generation system possesses strong technical background knowledge and reasoning capabilities, and can make reasonable expansions and additions based on technical logic, to ensure the richness and completeness of the generated content.

Implementation:
The embodiments of the present disclosure achieve content expansion through multi-level intelligent processing. For example, the input parsing proxy deeply understands the technical concepts and innovations of the user input; the research and analysis proxy provides the relevant technical background and best practices; and the content writing proxy supplements details reasonably based on technical logic and industry common sense. The intelligent document generation system also has a dedicated knowledge base and reasoning engine, and can generate the extended content conforming to technical logic based on the existing information.

### Overall Effect Summary

In summary, the method for generating the document provided in the embodiments of the present disclosure can achieve significant technological advancements in document generation quality, efficiency, standardization and degree of intelligence through professional proxy collaboration, standardized workflows, intelligent content expansion and multi-level quality control, thereby effectively solving problems such as insufficient professional depth, low collaboration efficiency, non-standard format and limited content expansion capability in traditional solutions, and providing strong technical support for enterprise technological innovation and document writing.

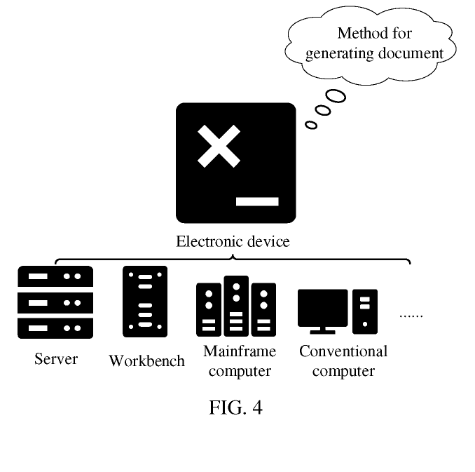

Referring to FIG. 4, FIG. 4 is a schematic diagram of an application scenario of a method for generating a document according to an embodiment of the present disclosure.

The method for generating the document according to the embodiment of the present disclosure is applied to an electronic device. Here, the electronic device may be a server or a terminal device, Here, the terminal device may be a workbench, a mainframe computer, a conventional computer, or other similar computing device.

Here, the electronic device is configured to: obtain a document generation request; obtain a task planning result based on the document generation request by using an orchestration agent, where the task planning result includes a plurality of sub-tasks; for each of the plurality of sub-tasks, generate a tool module corresponding to the sub-task by using the orchestration agent, to obtain a plurality of tool modules in one-to-one correspondence to the plurality of sub-tasks; and generate a target document by using the plurality of tool modules to execute the plurality of sub-tasks.

It should be noted that the schematic diagram of the application scenario shown in FIG. 4 is only illustrative and not restrictive in the embodiment of the present disclosure, those skilled in the art can make various obvious changes and/or replacements based on the example of FIG. 4, and the obtained technical solutions still belong to the disclosure scope of the embodiments of the present disclosure.

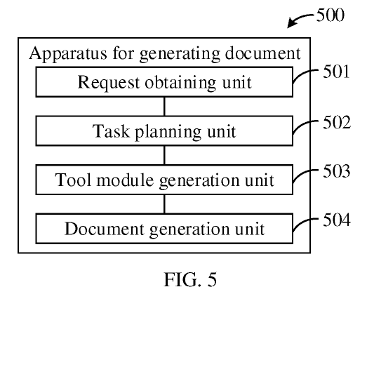

In order to better implement the above-mentioned method for generating the document, an embodiment of the present disclosure further provides an apparatus for generating a document, which can be integrated into an electronic device. Here, the electronic device may be a server or a terminal device, Here, the terminal device may be a workbench, a mainframe computer, a conventional computer, or other similar computing device. Hereinafter, an apparatus for generating a document 500 according to an embodiment of the present disclosure will be described in combination with the schematic structural block diagram shown in FIG. 5.

The apparatus for generating the document 500 includes: a request obtaining unit 501 configured to obtain a document generation request; a task planning unit 502 configured to obtain a task planning result based on the document generation request by using an orchestration agent, where the task planning result includes a plurality of sub-tasks; a tool module generation unit 503 configured to, for each of the plurality of sub-tasks, generate a tool module corresponding to the sub-task by using the orchestration agent, to obtain a plurality of tool modules in one-to-one correspondence to the plurality of sub-tasks; and a document generation unit 504 configured to generate a target document by using the plurality of tool modules to execute the plurality of sub-tasks.

In some optional implementations, the tool module generation unit 503 is configured to: determine a tool type corresponding to the sub-task, where the tool type is agent type or code type; when the tool type corresponding to the sub-task is the agent type, generate a sub-agent corresponding to the sub-task as the tool module; and/or, when the tool type corresponding to the sub-task is the code type, generate a code tool corresponding to the sub-task as the tool module.

In some optional implementations, the tool module generation unit 503 is configured to: obtain description information of the sub-task; when determining based on the description information of the sub-task that execution of the sub-task requires cognitive and decision-making abilities, determine the agent type as the tool type corresponding to the sub-task; and/or, when determining based on the description information of the sub-task that execution of the sub-task involves a predefined external operation process, determine the code type as the tool type corresponding to the sub-task.

In some optional implementations, the tool module generation unit 503 is configured to: obtain description information of the sub-task; generate an agent definition based on the description information of the sub-task, where the agent definition includes at least one of role description, capability boundary, first data structure definition, normative requirement or interaction rule; and generate the sub-agent corresponding to the sub-task based on the agent definition.

In some optional implementations, the tool module generation unit 503 is configured to: obtain description information of the sub-task; generate a code definition based on the description information of the sub-task, where the code definition includes at least one of function signature or second data structure definition; and generate the code tool corresponding to the sub-task based on the code definition.

In some optional implementations, the tool module generation unit 503 is configured to: generate a code segment based on the code definition, where the code segment encapsulates functional logic required to implement the sub-task; test the code segment to obtain a test result; and when the test result indicates that the code segment is available, generate the code tool corresponding to the sub-task based on the code segment.

In some optional implementations, the document generation unit 504 is configured to: determine a current module from the plurality of tool modules according to an execution order of the plurality of sub-tasks; determine a current task corresponding to the current module from the plurality of sub-tasks; execute the current task by invoking the current module to obtain an intermediate result; and generate the target document based on the intermediate result.

In some optional implementations, the document generation unit 504 is configured to: execute the current task by invoking the current module to obtain an initial result; determine a unified data format requirement; and perform format conversion on the initial result according to the unified data format requirement to obtain the intermediate result.

In some optional implementations, the apparatus for generating the document 500 further includes: a quality detection unit configured to perform quality detection on the target document to obtain a detection result; and a tool destruction unit configured to, when the detection result indicates that the target document is available, destroy the plurality of tool modules.

In the embodiment of the present disclosure, the specific functions and examples of the units in the apparatus for generating the document 500 can refer to the relevant description of the corresponding steps in the above-mentioned embodiments of the method for generating the document, and will not be repeated here.

In the technical solution of the present disclosure, the acquisition, storage and application of the user's personal information involved are in compliance with relevant laws and regulations, and do not violate public order and good customs.

According to the embodiments of the present disclosure, the present disclosure further provides an electronic device, a readable storage medium and a computer program product.

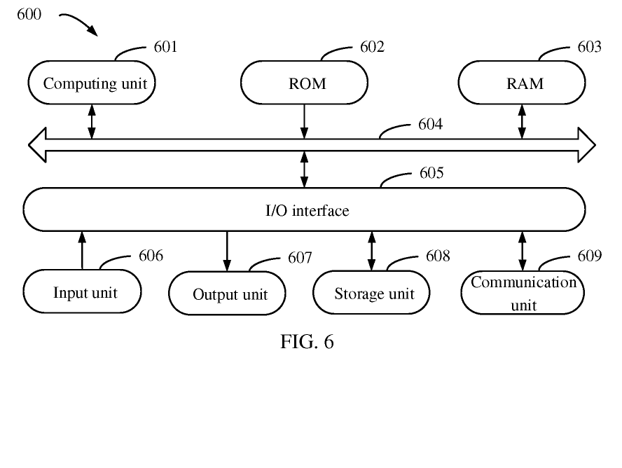

FIG. 6 shows a schematic structural block diagram of an exemplary electronic device 600 that may be used to implement the embodiments of the present disclosure. The electronic device 600 is intended to represent various forms of digital computers, such as a vehicle-mounted computing device, a laptop, a desktop, a workstation, a personal digital assistant, a server, a blade server, a mainframe computer, and other suitable computers. The electronic device 600 may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 6, the electronic device 600 includes a computing unit 601 that may perform various appropriate actions and processes according to a computer program stored in a Read-Only Memory (ROM) 602 or a computer program loaded from a storage unit 608 into a Random Access Memory (RAM) 603. Various programs and data required for the operations of the electronic device 600 may also be stored in the RAM 603. The computing unit 601, the ROM 602 and the RAM 603 are connected to each other through a bus 604. The Input/Output (I/O) interface 605 is also connected to the bus 604.

A plurality of components in the electronic device 600 are connected to the I/O interface 605, and include: an input unit 606 such as a keyboard, a mouse, or the like; an output unit 607 such as various types of renderers, speakers, or the like; a storage unit 608 such as a magnetic disk, an optical disk, or the like; and a communication unit 609 such as a network card, a modem, a wireless communication transceiver, or the like. The communication unit 609 allows the electronic device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 601 performs various methods and processes described above, such as the method for generating the document. For example, in some implementations, the method for generating the document may be implemented as a computer software program tangibly contained in a computer-readable medium, such as the storage unit 608. In some implementations, a part or all of the computer program may be loaded and/or installed on the electronic device 600 via the ROM 602 and/or the communication unit 609. When the computer program is loaded into the RAM 603 and executed by the computing unit 601, one or more steps of the method for generating the document described above may be performed. Alternatively, in other implementations, the computing unit 601 may be configured to perform the method for generating the document by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System On Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, an RAM, an ROM, an Erasable Programmable Read-Only Memory (EPROM) or a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a rendering device (e.g., a Cathode Ray Tube (CRT) renderer or a Liquid Crystal Display (LCD)) for rendering information to the user; and a keyboard and a pointing device (e.g., a mouse or a trackball) through which the user may provide input to the computer. Other types of devices are also used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

An embodiment of the present disclosure further provides a non-transitory computer-readable storage medium storing a computer instruction thereon, and the computer instruction is used to cause a computer to execute the method for generating the document described above.

An embodiment of the present disclosure further provides a computer program product including a computer program, and the computer program implements the method for generating the document, when executed by a processor.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein. Moreover, the relational terms such as "first" and "second" in the present disclosure are only used to distinguish one entity or operation from another entity or operation, and do not necessarily require or imply any such actual relationship or sequence between these entities or operations. Furthermore, "a plurality of" in the present disclosure can be understood as at least two.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for generating a document, comprising:
obtaining a document generation request;
obtaining a task planning result based on the document generation request by using an orchestration agent, wherein the task planning result comprises a plurality of sub-tasks;
for each of the plurality of sub-tasks, generating a tool module corresponding to the sub-task by using the orchestration agent, to obtain a plurality of tool modules in one-to-one correspondence to the plurality of sub-tasks; and
generating a target document by using the plurality of tool modules to execute the plurality of sub-tasks.

2. The method of claim 1, wherein the generating of the tool module corresponding to the sub-task, comprises:
determining a tool type corresponding to the sub-task, wherein the tool type comprises at least one of agent type or code type;
in a case where the tool type corresponding to the sub-task comprises the agent type, generating a sub-agent corresponding to the sub-task as the tool module;
and/or, in a case where the tool type corresponding to the sub-task comprises the code type, generating a code tool corresponding to the sub-task as the tool module.

3. The method of claim 2, wherein the determining of the tool type corresponding to the sub-task, comprises:
obtaining description information of the sub-task;
in a case where it is determined, based on the description information of the sub-task, that execution of the sub-task requires cognitive and decision-making abilities, determining the agent type as the tool type corresponding to the sub-task;
and/or, in a case where it is determined, based on the description information of the sub-task, that execution of the sub-task involves a predefined external operation process, determining the code type as the tool type corresponding to the sub-task.

4. The method of claim 2, wherein the generating of the sub-agent corresponding to the sub-task, comprises:
obtaining description information of the sub-task;
generating an agent definition based on the description information of the sub-task, wherein the agent definition comprises at least one of role description, capability boundary, first data structure definition, normative requirement or interaction rule; and
generating the sub-agent corresponding to the sub-task based on the agent definition.

5. The method of claim 2, wherein the generating of the code tool corresponding to the sub-task, comprises:
obtaining description information of the sub-task;
generating a code definition based on the description information of the sub-task, wherein the code definition comprises at least one of function signature or second data structure definition; and
generating the code tool corresponding to the sub-task based on the code definition.

6. The method of claim 5, wherein the generating of the code tool corresponding to the sub-task based on the code definition, comprises:
generating a code segment based on the code definition, wherein the code segment encapsulates functional logic required to implement the sub-task;
testing the code segment to obtain a test result; and
in a case where the test result indicates that the code segment is available, generating the code tool corresponding to the sub-task based on the code segment.

7. The method of claim 1, wherein the generating of the target document by using the plurality of tool modules to execute the plurality of sub-tasks, comprises:
determining a current module from the plurality of tool modules according to an execution order of the plurality of sub-tasks;
determining a current task corresponding to the current module from the plurality of sub-tasks;
executing the current task by invoking the current module to obtain an intermediate result; and
generating the target document based on the intermediate result.

8. The method of claim 7, wherein the executing of the current task by invoking the current module to obtain the intermediate result, comprises:
executing the current task by invoking the current module to obtain an initial result;
determining a unified data format requirement; and
performing format conversion on the initial result according to the unified data format requirement to obtain the intermediate result.

9. The method of claim 7, further comprising:
performing quality detection on the target document to obtain a detection result; and
in a case where the detection result indicates that the target document is available, destroying the plurality of tool modules.

10. An electronic device, comprising:
at least one processor;
a memory connected in communication with the at least one processor;
wherein the memory stores an instruction executable by the at least one processor, and the instruction, when executed by the at least one processor, enables the at least one processor to execute:
obtaining a document generation request;
obtaining a task planning result based on the document generation request by using an orchestration agent, wherein the task planning result comprises a plurality of sub-tasks;
for each of the plurality of sub-tasks, generating a tool module corresponding to the sub-task by using the orchestration agent, to obtain a plurality of tool modules in one-to-one correspondence to the plurality of sub-tasks; and
generating a target document by using the plurality of tool modules to execute the plurality of sub-tasks.

11. The electronic device of claim 10, wherein the instruction, when executed by the at least one processor, enables the at least one processor to execute the generating of the tool module corresponding to the sub-task, by:
determining a tool type corresponding to the sub-task, wherein the tool type comprises at least one of agent type or code type;
in a case where the tool type corresponding to the sub-task comprises the agent type, generating a sub-agent corresponding to the sub-task as the tool module;
and/or, in a case where the tool type corresponding to the sub-task comprises the code type, generating a code tool corresponding to the sub-task as the tool module.

12. The electronic device of claim 11, wherein the instruction, when executed by the at least one processor, enables the at least one processor to execute the determining of the tool type corresponding to the sub-task, by:
obtaining description information of the sub-task;
in a case where it is determined, based on the description information of the sub-task, that execution of the sub-task requires cognitive and decision-making abilities, determining the agent type as the tool type corresponding to the sub-task;
and/or, in a case where it is determined, based on the description information of the sub-task, that execution of the sub-task involves a predefined external operation process, determining the code type as the tool type corresponding to the sub-task.

13. The electronic device of claim 11, wherein the instruction, when executed by the at least one processor, enables the at least one processor to execute the generating of the sub-agent corresponding to the sub-task, by:
obtaining description information of the sub-task;
generating an agent definition based on the description information of the sub-task, wherein the agent definition comprises at least one of role description, capability boundary, first data structure definition, normative requirement or interaction rule; and
generating the sub-agent corresponding to the sub-task based on the agent definition.

14. The electronic device of claim 11, wherein the instruction, when executed by the at least one processor, enables the at least one processor to execute the generating of the code tool corresponding to the sub-task, by:
obtaining description information of the sub-task;
generating a code definition based on the description information of the sub-task, wherein the code definition comprises at least one of function signature or second data structure definition; and
generating the code tool corresponding to the sub-task based on the code definition.

15. The electronic device of claim 14, wherein the instruction, when executed by the at least one processor, enables the at least one processor to execute the generating of the code tool corresponding to the sub-task based on the code definition, by:
generating a code segment based on the code definition, wherein the code segment encapsulates functional logic required to implement the sub-task;
testing the code segment to obtain a test result; and
in a case where the test result indicates that the code segment is available, generating the code tool corresponding to the sub-task based on the code segment.

16. A non-transitory computer-readable storage medium storing a computer instruction thereon, wherein the computer instruction is used to cause a computer to execute:
obtaining a document generation request;
obtaining a task planning result based on the document generation request by using an orchestration agent, wherein the task planning result comprises a plurality of sub-tasks;
for each of the plurality of sub-tasks, generating a tool module corresponding to the sub-task by using the orchestration agent, to obtain a plurality of tool modules in one-to-one correspondence to the plurality of sub-tasks; and
generating a target document by using the plurality of tool modules to execute the plurality of sub-tasks.

17. The non-transitory computer-readable storage medium of claim 16, wherein the computer instruction is used to cause the computer to execute the generating of the tool module corresponding to the sub-task, by:
determining a tool type corresponding to the sub-task, wherein the tool type comprises at least one of agent type or code type;
in a case where the tool type corresponding to the sub-task comprises the agent type, generating a sub-agent corresponding to the sub-task as the tool module;
and/or, in a case where the tool type corresponding to the sub-task comprises the code type, generating a code tool corresponding to the sub-task as the tool module.

18. The non-transitory computer-readable storage medium of claim 17, wherein the computer instruction is used to cause the computer to execute the determining of the tool type corresponding to the sub-task, by:
obtaining description information of the sub-task;
in a case where it is determined, based on the description information of the sub-task, that execution of the sub-task requires cognitive and decision-making abilities, determining the agent type as the tool type corresponding to the sub-task;
and/or, in a case where it is determined, based on the description information of the sub-task, that execution of the sub-task involves a predefined external operation process, determining the code type as the tool type corresponding to the sub-task.

19. The non-transitory computer-readable storage medium of claim 17, wherein the computer instruction is used to cause the computer to execute the generating of the sub-agent corresponding to the sub-task, by:
obtaining description information of the sub-task;
generating an agent definition based on the description information of the sub-task, wherein the agent definition comprises at least one of role description, capability boundary, first data structure definition, normative requirement or interaction rule; and
generating the sub-agent corresponding to the sub-task based on the agent definition.

20. The non-transitory computer-readable storage medium of claim 17, wherein the computer instruction is used to cause the computer to execute the generating of the code tool corresponding to the sub-task, by:
obtaining description information of the sub-task;
generating a code definition based on the description information of the sub-task, wherein the code definition comprises at least one of function signature or second data structure definition; and
generating the code tool corresponding to the sub-task based on the code definition.
